(19) United States
(12) Patent Application Publication
(10) Pub. No.: US 2025/0181965 A1
(43) Pub. Date: Jun. 5, 2025

(54) SYSTEM FOR CONVERTING PROPENSITY MODEL OUTPUT INTO INSIGHT ENHANCED CONTEXTUAL REASONS FOR THE OUTPUT

(71) Applicant: Intuit Inc., Mountain View, CA (US)

(72) Inventors: Arul Samuel RAJKUMAR, San Jose, CA (US); Grace WU, Redwood City, CA (US); Erin-Todd HANSEN, Boise, ID (US); Ernesto M. Melendez, Tucson, AZ (US); Divya BEERAM, Mountain View, CA (US)

(73) Assignee: Intuit Inc., Mountain View, CA (US)

(21) Appl. No.: 18/525,728

(22) Filed: Nov. 30, 2023

(51) Int. Cl. G06N 20/00; G06N 7/01

(52) U.S. Cl. CPC G06N 20/00; G06N 7/01

(57) ABSTRACT

A method including applying a propensity model to a subject vector to generate a propensity value estimating a probability that a subject will perform an action. The subject vector has a data structure having features storing information regarding the subject. The method also includes applying a Shapley additive explanation tool to the propensity model to generate a subset of the features that contributed to the propensity value more than a remaining set of the features. The method also includes selecting an actionable feature from the subset of the features. The actionable feature includes a feature in the subset that an entity is able to influence. The method also includes applying a correlation model to labels for training data and the actionable feature to generate an output that describes a reason why the subject performs the action. The method also includes presenting the actionable feature and the output.

### BACKGROUND

Machine learning models may be applied by computing systems to analyze data in order to find patterns in the data and make predictions according to the patterns. For example, a machine learning model may be applied to user data to generate a prediction regarding what action that user may be likely to perform. The machine learning model will produce a likelihood that the user will perform the predicted action.

For example, a machine learning model may predict that, in a complex environment in which many chemical reactions may take place, a specific chemical reaction may take place. The same, or different, machine learning model may also predict some change to the complex environment which increases or decreases the probability that the specific chemical reaction may take place.

However, the machine learning model may be a “black box,” meaning that the computer scientist, technician, or other individual reviewing the output of the machine learning model may not understand why the machine learning model output the predicted action, the recommended action, or a reason for why the original user is expected to perform the predicted action. Such knowledge regarding “why” the machine learning model predicted the output may be desirable.

### SUMMARY

One or more embodiments provide for a method. The method includes applying a propensity model to a subject vector to generate a propensity value estimating a probability that a subject will perform an action. The subject vector has a data structure having features storing information regarding the subject. The method also includes applying, after applying the propensity model to the subject vector, a Shapley additive explanation tool to the propensity model to generate a subset of the features that contributed to the propensity value more than a remaining set of the features. The method also includes selecting an actionable feature from the subset of the features. The actionable feature includes a feature in the subset that an entity is able to influence. The method also includes applying a correlation model to labels for training data and the actionable feature to generate an output that describes a reason why the subject performs the action. The method also includes presenting the actionable feature and the output.

One or more embodiments also provide for a system. The system includes a processor and a data repository in communication with the processor. The data repository stores a subject vector. The subject vector has a data structure having features storing information regarding a subject. The data repository also stores a propensity value estimating a probability that the subject will perform an action. The data repository also stores a subset of the features that contributed to the propensity value more than a remaining set of the features. The data repository also stores an actionable feature including a feature in the subset that an entity is able to influence. The data repository also stores labels for training data. The data repository also stores an output that describes a reason why the subject performs the action. The system also includes a propensity model which, when applied by the processor to the subject vector, generates the propensity value. The system also includes a Shapley additive explanation tool which, when applied by the processor to the propensity model after generating the propensity value, generates the subset of the features. The system also includes a correlation model which, when applied by the processor to the labels for training data and the actionable feature, generates the output.

One or more embodiments also provide for another method. The method includes applying a propensity model to a subject vector to generate a propensity value estimating a probability that a subject will perform an action. The subject vector has a data structure including features storing information regarding the subject. The method also includes applying, after applying the propensity model to the subject vector, a Shapley additive explanation tool to the propensity model to generate a subset of the features that contributed to the propensity value more than a remaining set of the features. The method also includes selecting an actionable feature from the subset of the features. The actionable feature includes a feature in the subset that an entity is able to influence. The method also includes applying a correlation model to labels for training data and the actionable feature to generate an output that describes a reason why the subject performs the action. The method also includes displaying, on a graphical user interface, a display including the propensity value, the actionable feature, and the output. The method also includes displaying, on the graphical user interface, a widget requesting user input whether the display was helpful. The method also includes receiving a user response from activation of the widget. The method also includes adding the user response to a training data set to generate a revised training data set. The method also includes retraining the correlation model with the revised training data set.

Other aspects of one or more embodiments will be apparent from the following description and the appended claims.

### BRIEF DESCRIPTION OF DRAWINGS

FIG. 1A and FIG. 1B shows a computing system, in accordance with one or more embodiments.

FIG. 2A and FIG. 2B show flowcharts of methods for converting propensity model output into insight enhanced contextual reasons for the output, in accordance with one or more embodiments.

FIG. 3 shows an example of a system for converting propensity model output into insight enhanced contextual reasons for the output, in accordance with one or more embodiments.

FIG. 4A, FIG. 4B, and FIG. 4C show an example of a method for converting propensity model output into insight enhanced contextual reasons for the output, in accordance with one or more embodiments.

FIG. 5A and FIG. 5B show an example of a computing system and a network environment, in accordance with one or more embodiments.

Like elements in the various figures are denoted by like reference numerals for consistency.

### DETAILED DESCRIPTION

One or more embodiments are directed to a system and method for converting propensity model output into insight enhanced contextual reasons for the output. Thus, one or more embodiments may be characterized as an explainable artificial intelligence (XAI) system, and methods thereof.

In summary, one or more embodiments combine a propensity model, a Shapley additive explanation tool, a correlation model, and a repository of domain knowledge to generate an XAI context. The XAI context may be expressed as an actionable feature and an output that describes a reason why a subject performs an action. The actionable feature is a feature (defined below) that i) most likely contributed to the predicted propensity of the subject to perform an action, and also ii) represents some feature that can be controlled or influenced. The combined XAI context may be presented in the form of a graphical user interface (GUI) that may assist a computer scientist, technician, or other user to understand why the subject may behave in a certain way, and also to suggest what action may be taken to influence the future behavior of the subject.

The operational details of one or more embodiments are now summarized. Initially, a propensity model is used to predict a probability that a subject will perform the action. Then, a Shapley additive explanation tool is applied, after generating the probability, to the propensity model to determine a subset of features that most contributed to the predicted propensity value.

The actionable feature is selected from the subset of features on the basis that the actionable feature is some feature which may be controlled or influenced. A correlation model is applied to labels for training data and the actionable feature to generate an output that describes a predicted reason why the subject may perform the action. Finally, the actionable feature and the output that describes the reason why the subject may perform the action are presented together.

One or more embodiments address one or more technical challenges. In particular, machine learning models are commonly understood as being “black boxes.” The term “black box” means that the execution of a machine learning model and its layers may be sufficiently complex that the human mind is incapable of identifying the patterns in data discerned by the machine learning model to generate the output. Thus, even if a machine learning model generates an accurate prediction, it is difficult or impossible to directly query a machine learning model as to the basis for the machine learning model output. An even more serious technical challenge is attempting to discern why the machine learning model predicted an output.

For example, the basis for a machine learning model output may be one or more identifiable features in a vector input to the machine learning model. However, determining why those identifiable features served as the basis for machine learning model output may be extremely challenging.

The systems and methods summarized above, and described in more detail below, address the above-described technical challenges. In particular, one or more embodiments summarized above, and described in more detail below, may be used to determine not only the basis for the machine learning model output, but also a predicted reason why a machine learning model predicted the output. The combined knowledge of the basis for the machine learning model output and the reason why the basis led to the predicted output may provide a useful source of information for influencing the behavior of a subject.

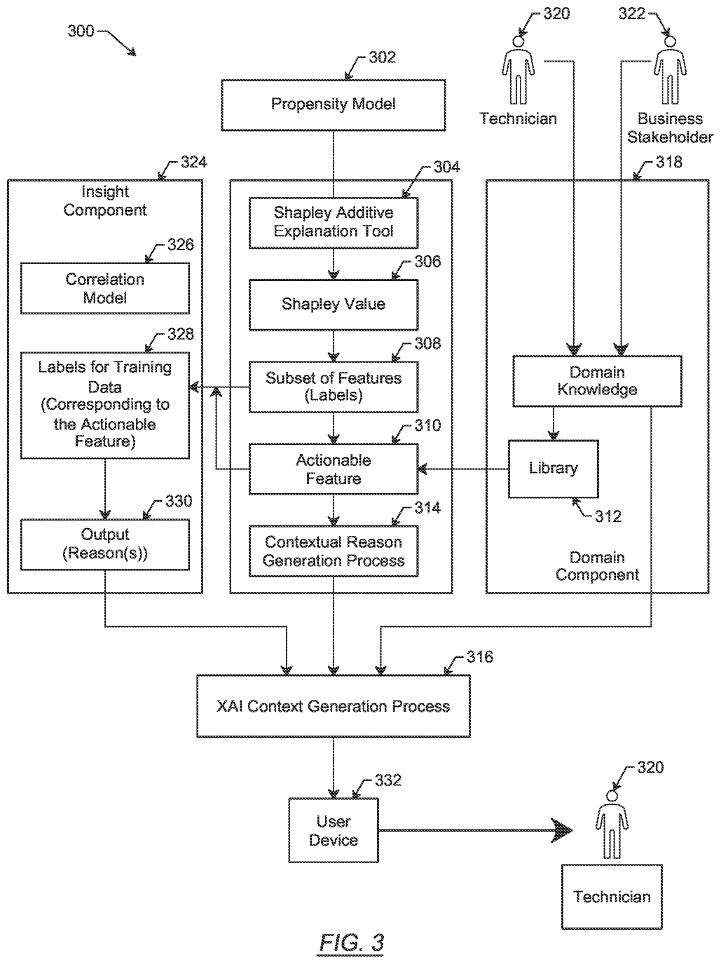

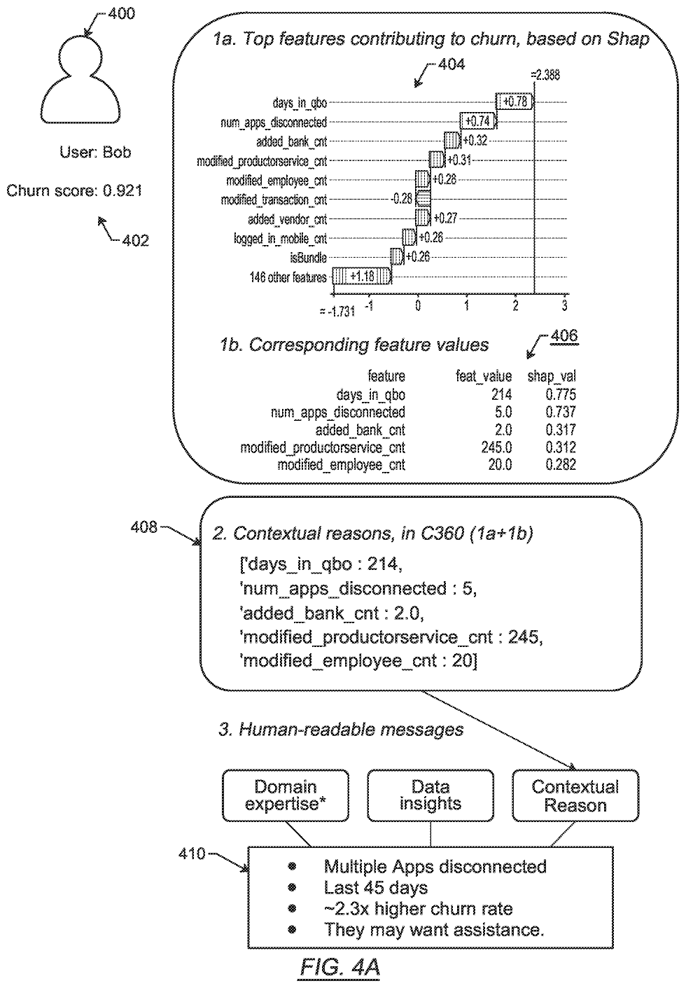

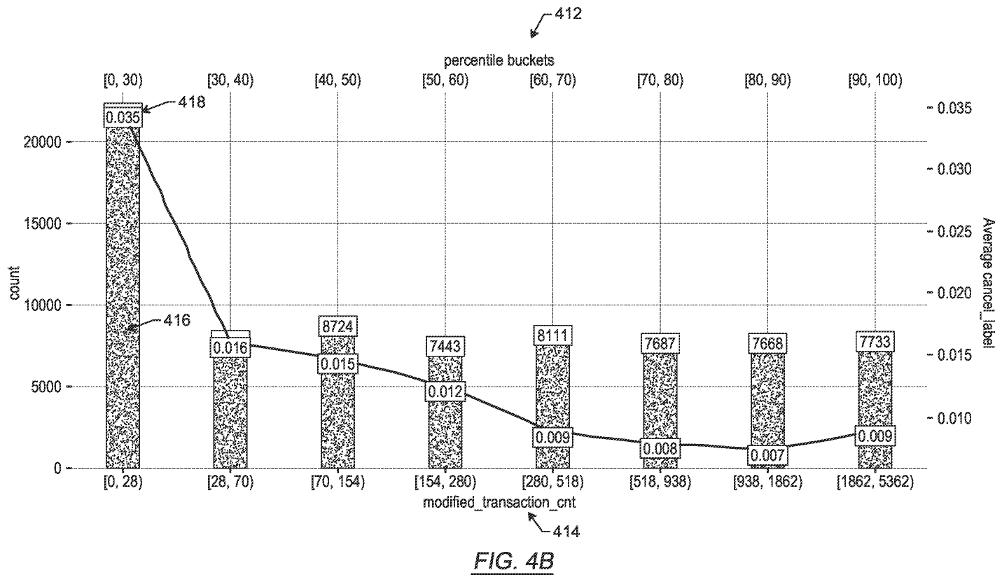

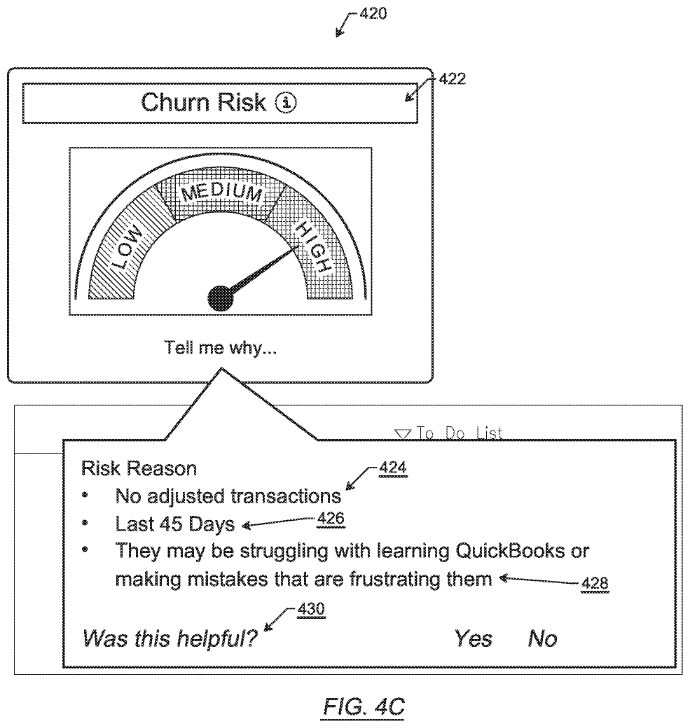

Note that while the example of the one or more embodiments described with respect to FIG. 3 through FIG. 4C is in the context of predicting and influencing a churn rate for users of a software application, one or more embodiments represent an advance in data science. Thus, one or more embodiments may be extended to many applications. For example, the improved machine learning model XAI techniques described herein may be applied to scientific research, such as the chemistry example mentioned above. In another example, the improved machine learning model XAI techniques described herein may have law enforcement applications (predicting and influencing the behavior of criminals), military applications (predicting and influencing the behavior of soldiers), and other scientific research applications (predicting and influencing the behavior of complex physical systems). Thus, the examples provided herein do not limit one or more embodiments.

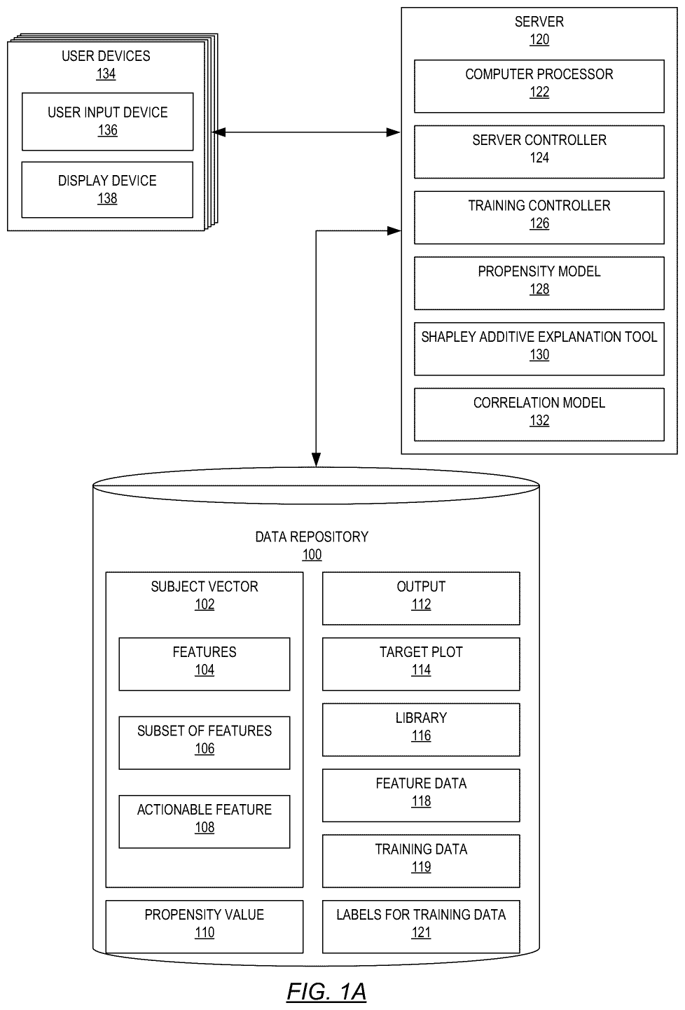

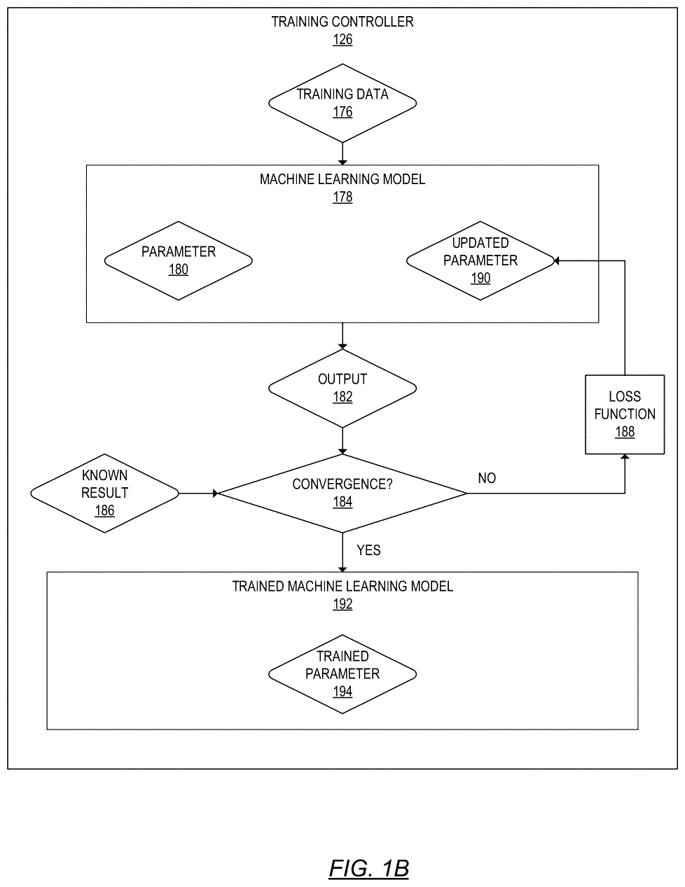

Attention is now turned to the figures. FIG. 1A shows a computing system, in accordance with one or more embodiments. The system shown in FIG. 1A includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) may store a subject vector (102). The subject vector (102) is a data structure having a number of features storing information regarding the subject.

The subject vector (102) is a type of vector. A vector is a computer-readable data structure defined as a matrix having a predefined dimensionality. While the matrix may have two or more dimensions, in many cases the vector is an “N” by 1 dimensional matrix, where “N” is a predetermined number. The process of generating the vector data structure is known as vectorization.

The vector is characterized by features (104) and values. The features (104) are a data type of interest, such as for example the presence or absence of a physical property, a thickness value, a measurement for a physical dimension, etc. A value is a value for a corresponding feature, as represented by a number. Thus, the vector has “N” features (104) and a corresponding number of values for the “N” features (104). The values for the “N” features (104) may be logically stored in the “N” by one dimensional matrix. In the case of the subject vector (102), the features (104) and values of the subject vector (102) store properties (i.e., the features (104)) and values of the properties (values) that relate to the subject.

In turn, a subject is a target entity of interest for which it is desirable to predict the subject's behavior and to discern a reason why a machine learning model predicts a certain behavior from the subject. The subject may be a person, machine, physical property (chemicals), information system, or any other entity which exhibits a behavior that may be observed.

The subject vector (102) may include a subset of features (106), which is a set from less than all of the features (104) to the complete set of the features (104). However, the subset of features (106) is those of the features (104) that are returned by a Shapley additive explanation tool (defined below) when applied to the propensity model. Thus, the subset of features (106) are those features that contributed to a propensity value (110) (defined below) more than a remaining set of the features (104). The remaining set of the features (104) are those of the features (104) that remain outside of the subset of features (106), but within the complete set of the features (104).

The subject vector (102) may include an actionable feature (108). The actionable feature is a feature in the subset of features (106) that an entity is able to influence. The entity has an ability to influence the subject in some way. For example, the entity may be another person, a computer program, a chemical process, a physical property, etc. The actionable feature (108) may be multiple features, in one or more embodiments.

The data repository (100) also stores the propensity value (110). The propensity value (110) is a number that is output by a propensity model (128) (defined below). Thus, the propensity value (110) is a number reflecting an estimated probability that a subject will perform an action.

The data repository (100) also stores an output (112). The output (112) is an output of a correlation model (132) (defined below). The output (112) is alphanumeric symbols that describe one or more reasons why the subject performs the action. Thus, for example, the output (112) may be text for display to a user, may be numbers for further computer processor functions, etc.

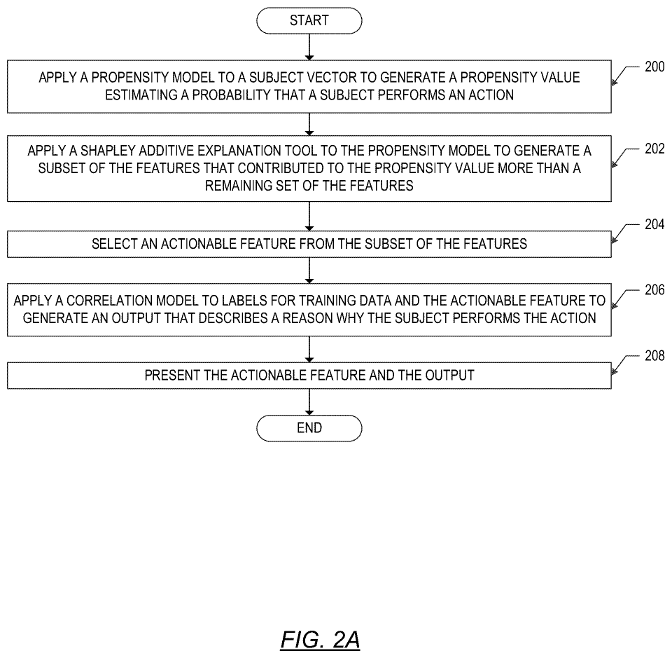

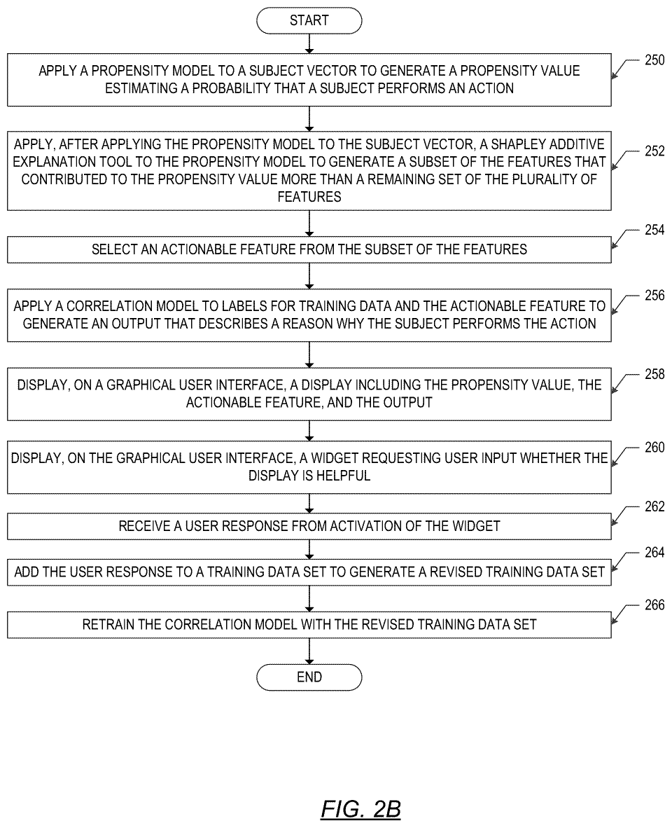

The data repository (100) also may store a target plot (114). The target plot (114) is graph, displayable on a graphical user interface, that illustrates a correlation between labels for training data to the actionable feature (108). An example of the target plot (114) is shown in FIG. 4B. The target plot (114) is useful for visualization, but is not necessarily used in the method of FIG. 2.

The data repository (100) also stores a library (116). The library (116) is a data structure storing computer readable data that relates to one or more possible actionable features. The library (116) may define those features that are actionable. Thus, for example, once the subset of features (106) is determined by the Shapley additive explanation tool (130) (defined below), the library (116) may be consulted to determine which of the subset of features (106) may be considered the actionable feature (108) (or multiple actionable features). Those features within the subset of features (106) that also exist within the library (116) may be actionable features, such as the actionable feature (108).

The data repository (100) also stores feature data (118). The feature data (118) is data regarding multiple users and that corresponds to the actionable feature (108). An example of feature data may be various information about the multiple subjects, combined with observed behaviors of the multiple subjects.

The data repository (100) also stores training data (119). The training data (119) is data which may be used to train the propensity model (128), defined below. Specifically, the training data (119) may include, for each of many subjects, a multiple different features and corresponding values for the features. Furthermore, if the propensity model (128) were applied to the training data (119), then the resulting output of the propensity model (128) would be known in advance. This fact is useful during the training process explained with respect to FIG. 2B.

The data repository (100) also stores labels for training data (121). The labels for training data (121) are one or more labels that are associated with one or more of the features in the training data (119). In other words, each feature may have one or more labels, though it is not necessarily the case that all features in the training data (119) have labels. The labels define known properties of the features that exist in the training data (119). The labels may be used both during training of the propensity model (128) and during application of the correlation model (132) to generate the output (112).

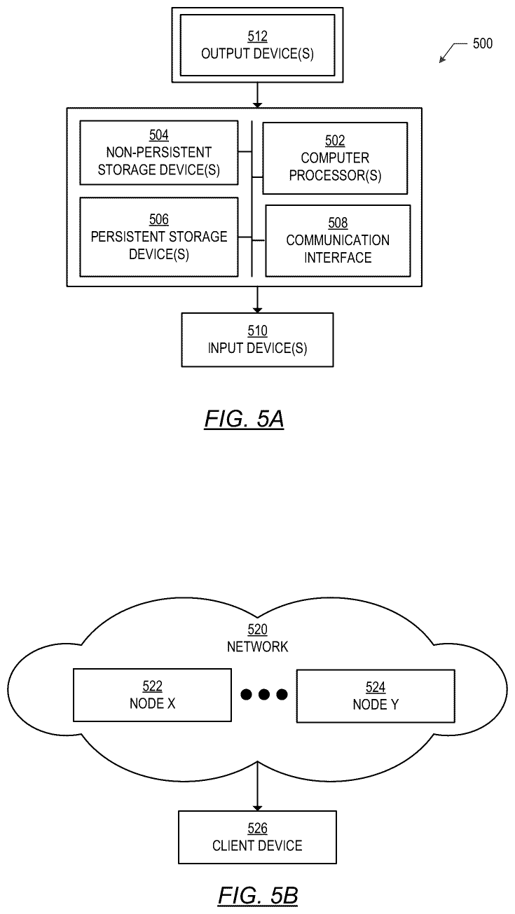

The system shown in FIG. 1A may include additional components. For example, the system shown in FIG. 1A may include a server (120). The server (120) is one or more computers, possibly operating in a distributed computing environment. the server (120) may be, for example, the computing system (500) shown in FIG. 5A.

The server (120) may include a computer processor (122), which represents one or more hardware or virtual processors which may execute one or more of the controllers, models, and tools described herein. The computer processor (122) may be the computer processor(s) (502) of FIG. 5A.

The server (120) also may include a server controller (124). The server controller (124) is software or application specific hardware which may execute the methods of FIG. 2A or FIG. 2B, and which may control various operational aspects of the propensity model (128), the Shapley additive explanation tool (130), and the correlation model (132). As an example, the server controller (124) may, when applied by the processor to the actionable feature (108) and the output (112), generate a graphical user interface (GUI) that displays the actionable feature (108), the output (112), and a suggested action. An example of the GUI is shown in FIG. 4C.

The server (120) also may store a training controller (126). The training controller (126) is software or application specific hardware which may train one or more of the machine learning models described herein, such as the propensity model (128) and the correlation model (132). The details of the training controller (126) are described with respect to FIG. 1B.

The server (120) also may store a propensity model (128). The propensity model (128) is a predictive machine learning model that may forecast the behavior of the subject based on past behaviors of the subject. A propensity model uses a range of data sets, such as information about the subject and previous behaviors of the subject, to analyze and identify a likelihood of the subject performing a certain action in the future. The propensity model (128) may be a supervised machine learning model, a decision tree machine learning model, a neural network, or other types of predictive machine learning models.

The server (120) also may store a Shapley additive explanation tool (130). The Shapley additive explanation tool (130) is a computer algorithm, or application specific hardware, that when applied to the propensity model (128) generates Shapley values from game theory. The Shapley values may be used to compute a contribution of each feature analyzed by the propensity model (128) to generate the prediction of the Shapley additive explanation tool (130). There are different variants of the Shapley additive explanation tool (130), such as a KernalSHAP and a TreeSHAP that apply to different types of machine learning models. The type of the Shapley additive explanation tool (130) depends on the type of model used for the propensity model (128).

The server (120) also stores a correlation model (132). The correlation model (132) is a machine learning model, or some other algorithm, that may predict or identify a correlation between the actionable feature (108) and a reason why the subject may perform the action. The input to the correlation model (132) is the labels for training data (121), defined below, and the actionable feature (108). The output of the correlation model (132) is the reason why the subject may perform the action.

The system shown in FIG. 1A also may include other features. For example, the system shown in FIG. 1A may include one or more user devices (134). However, the user devices (134) may be remote user devices (i.e. devices not belonging to the system of FIG. 1A, but rather belonging to remote users that may access or interact with the server (120) in some way).

Each of the user devices (134) may include one or more user input devices, such as the user input device (136). The user input devices may be a device which a user may use to interact with the user devices (134). Examples of the user input device (136) may include a keyboard, a mouse, a microphone, a touchscreen, a haptic device, a camera, etc.

Each of the user devices (134) may include one or more display devices, such as the display device (138). The display devices may be a device which a user may use to view information generated or accessed by the user devices (134). Examples of the display device (138) may be a monitor, a television, a touchscreen, a haptic device, a speaker, etc.

Attention is turned to FIG. 1B, which shows the details of the training controller (126). The training controller (126) is a training algorithm, implemented as software or application specific hardware, that may be used to train one or more the machine learning models described with respect to the computing system of FIG. 1A.

In general, machine learning models are trained prior to being deployed. The process of training a model, briefly, involves iterative testing of a model against test data for which the final result is known, comparing the test results against the known result, and using the comparison to adjust the model. The process is repeated until the results do not improve more than some predetermined amount, or until some other termination condition occurs. After training, the final adjusted model is applied to unknown data (i.e., data for which a prediction is not known in advance) in order to make predictions.

In more detail, training starts with training data (176). The training data (176) is data for which the final result is known with certainty. For example, if the machine learning task is to identify whether two names refer to the same entity, then the training data (176) may be name pairs for which it is already known whether any given name pair refers to the same entity. In an embodiment, the training data (176) may be the training data (119) in FIG. 1A.

The training data (176) is provided as input to the machine learning model (178). The machine learning model (178) may be characterized as a program that has adjustable parameters. The program is capable of learning and recognizing patterns to make predictions. The output of the machine learning model may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a predetermined end condition of training has been reached. The predetermined end condition may vary based on the type of machine learning model being used (supervised versus unsupervised machine learning), or may be pre-determined by a user (e.g., convergence occurs after a set number of training iterations, described below).

In the case of supervised machine learning, the convergence process (184) compares the output (182) to a known result (186). The known result (186) is stored in the form of labels for the training data. For example, the known result for a particular entry in an output vector of the machine learning model may be a known value, and that known value is a label that is associated with the training data.

A determination is made whether the output (182) matches the known result (186) to a predetermined degree. The predetermined degree may be an exact match, a match to within a pre-specified percentage, or some other metric for evaluating how closely the output (182) matches the known result (186). Convergence occurs when the known result (186) matches the output (182) to within the predetermined degree.

In the case of unsupervised machine learning, the convergence process (184) may be compared to the output (182) to a prior output in order to determine a degree to which the current output changed relative to the immediately prior output or to the original output. Once the degree of changes fails to satisfy a threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188), but may be a scheme which attempts to guess how the parameter (180) may be changed so that the next execution of the machine learning model (178) using the training data (176) with the updated parameter (190) will have an output (182) that is more likely to result in convergence. (E.g., that the next execution of the machine learning model (178) is more likely to match the known result (186) (supervised learning), or which is more likely to result in an output that more closely approximates the prior output (one unsupervised learning technique), or which otherwise is more likely to result in convergence.)

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on unknown data for which the final result is not known. The output of the trained machine learning model (192) is then treated as a prediction of the information of interest relative to the unknown data.

While FIG. 1A and FIG. 1B show a configuration of components, other configurations may be used without departing from the scope of one or more embodiments. For example, various components may be combined to create a single component. As another example, the functionality performed by a single component may be performed by two or more components.

FIG. 2A and FIG. 2B show flowcharts of methods for converting propensity model output into insight enhanced contextual reasons for the output, in accordance with one or more embodiments. The methods of FIG. 2A and FIG. 2B may be implemented using the system shown in FIG. 1A or FIG. 1B, possibly using the computer processor(s) (502) of the computing system (500) shown in FIG. 5A.

Attention is first turned to the method of FIG. 2A, which describes a general method for generating and presenting an output that describes why a subject may perform an action. Step 200 includes applying a propensity model to a subject vector to generate a propensity value estimating a probability that a subject will perform an action. The subject vector may be a data structure having features storing information regarding the subject. The propensity model may be applied to the vector by the processor using the vector as input to the propensity model and then executing the propensity model.

Step 202 includes applying, after applying the propensity model to the subject vector, a Shapley additive explanation tool to the propensity model to generate a subset of the features that contributed to the propensity value more than a remaining set of the features. The Shapley additive explanation tool may be applied by executing the processor executing the tool on the propensity model after the propensity model has generated the propensity model. The output of the tool is the subset of features.

Step 204 includes selecting an actionable feature from the subset of the features. The actionable feature may be a feature in the subset that an entity is able to influence. The actionable feature may be selected by comparing the subset of the features to a library of actionable features. The feature corresponding to an entry in the library is selected as the actionable feature.

Note that, in an embodiment, the method of FIG. 2A may include building the library of actionable features from user input. For example, domain experts or computer scientists may identify those features included in the complete set of features that could be actionable, and those features may be stored in the library. Building the library may be performed any time prior to using the library to select the actionable feature at step 204.

Step 206 includes applying a correlation model to labels for training data and the actionable feature to generate an output that describes a reason why the subject performs the action. The correlation model may be applied by the processor by supplying the actionable feature and those of the labels for training data that are related to the actionable feature (and possibly up to all available labels of the training data, in addition to those for the actionable feature) as input to the correlation model. The correlation model is then executed. Applying the correlation model to the labels for training data and the actionable feature may correlate a highest average propensity value for the action by users to a common attribute among the users. The common attribute may be returned as the output describing a reason why the subject performs the action. Note that the term “a reason” may be multiple reasons in some embodiments.

In an embodiment, a target plot may be generated in order to display the correlations between the actionable feature, the labels for training data, and the common attribute that forms the output describing the reason why the subject performs the action. Generation of the target plot may proceed as follows any time after applying the correlation model at step 206.

First, feature data may be received from multiple subjects, including possibly the subject of interest. The feature data corresponds to the actionable feature. Then, the feature data is distributed into bins. Each of the bins represents a range of feature values for the actionable feature for the users. Each of the bins is associated with a value representing an average propensity value for the action for the users. The feature data, distributed in bins, may be the target plot. An example of the target plot and its use is provided with respect to FIG. 4B.

Step 208 includes presenting the actionable feature and the output. Presenting the actionable feature and the output may be performed using a number of different methods. For example, presenting may include displaying, on a display device the actionable feature and the output. Presenting also may include displaying the propensity value. Presenting may include storing the actionable feature and the output. Presenting may include passing the actionable feature and the output to some other computer function for further processing.

The method of FIG. 2A may be varied. For example, the method may include displaying, on a display device, a graphical user interface including the propensity value, the actionable feature, and the output. In this case, the method also may include displaying, on the graphical user interface, a widget requesting user input whether the display was helpful. Then, the method may include receiving a user response from activation of the widget. The method also may include retraining the correlation model based on the user response. Retraining the correlation model is a training method, as explained with respect to FIG. 1B.

Attention is now turned to FIG. 2B, which describes a method for training the correlation model used in the method of FIG. 2A. The method of FIG. 2B shares steps in common with the method of FIG. 2A, as noted below.

Step 250 includes applying a propensity model to a subject vector to generate a propensity value estimating a probability that a subject will perform an action. Step 250 is similar to step 200 of FIG. 2A.

Step 252 includes applying, after applying the propensity model to the subject vector, a Shapley additive explanation tool to the propensity model to generate a subset of the features that contributed to the propensity value more than a remaining set of the features. Step 252 is similar to step 202 of FIG. 2A.

Step 254 includes selecting an actionable feature from the subset of the features. Step 254 is similar to step 204 of FIG. 2A.

Step 256 includes applying a correlation model to labels for training data and the actionable feature to generate an output that describes a reason why the subject performs the action. Step 256 is similar to step 206 of FIG. 2A.

Step 258 includes displaying, on a graphical user interface, a display including the propensity value, the actionable feature, and the output. Step 258 is thus a form of presenting the actionable feature and the output, as described with respect to step 208 of FIG. 2A.

Step 260 includes displaying, on the graphical user interface, a widget requesting user input whether the display was helpful. Displaying the widget may take the form of a dialog box, a drop-down menu of options (e.g., yes, no), a button, or some other object with which a user may interact on a graphical user interface (GUI) presented to the user.

In any case, the widget provides some mechanism for the user to provide feedback regarding whether the display was helpful. The degree of feedback sought from the user may vary, from a simple “yes” or “no,” to free-form text provided by a user in a dialog box.

Step 262 includes receiving a user response from activation of the widget. The response may be received via the user using the widget. The response may be received over a network via a communication interface, or may be received directly if the user is directly interacting with the server implementing the method of FIG. 2B.

Step 264 includes adding the user response to a training data set to generate a revised training data set. The user response may be added to the training data set by vectorizing the user response. For example, free-form text may be converted into a vector by a natural language processing machine learning model (a large language model, or some other natural language processing model). A user response in the form of numerical feedback may be converted into a vector by associating the numerical feedback with features of the vector. Other vectorization procedures may be used.

Step 266 includes retraining the correlation model with the revised training data set. Retraining may be performed as described with respect to the training controller (126) of FIG. 1B.

While the various steps in the flowcharts of FIG. 2A and FIG. 2B are presented and described sequentially, at least some of the steps may be executed in different orders, may be combined or omitted, and at least some of the steps may be executed in parallel. Furthermore, the steps may be performed actively or passively.

FIG. 3 shows an example of a system for converting propensity model output into insight enhanced contextual reasons for the output, in accordance with one or more embodiments. The system shown in FIG. 3 may be a variation of the system shown in FIG. 1A, and may be implemented by the computing system (500) of FIG. 5A. Terms used in FIG. 3 that are in common with the system of FIG. 1A have definitions as described with respect to FIG. 1A.

The architecture (300) includes a propensity model (302). The propensity model (302) generates a propensity value. After generating the value, a Shapley additive explanation tool (304) is applied to the propensity model (302) to generate a Shapley value (306). The Shapley value (306) is used to identify the subset of features (308) that contributed to the propensity value more than a remaining suet of the features analyzed by the propensity model (302). The actionable features (310) are selected from the subset of features (308) by reference to a library (312).

The actionable features (310) may, in an embodiment, be used as part of a contextual reason generation process (314). The contextual reason generation process (314) may contribute to the generation of the XAI context generation process (316) described below.

Attention is turned to the library (312). The library (312) may be generated by a domain component (318) of the architecture (300). The domain component (318) is software or application specific hardware which may be used to build the library (312). The domain component (318) may include one or more users, such as a technician (320) or a business stakeholder (322), that apply their domain knowledge to the complete set of features which may be considered by the propensity model (302) when the propensity model (302) is executed by a processor. In another embodiment, the library (312) may be generated by using a large language model to analyze at least some of the complete set of features in the propensity model (302) and using semantic processing to identify those features in the complete set of features that may be actionable, in a semantic sense.

In addition, the architecture (300) includes an insight component (324). The insight component (324) may be software or application specific hardware which may be executed by a processor to generate the output (330) that describe one or more reasons why the subject may perform the action. The insight component (324) may apply a correlation model (326) to labels for training data (328) and the actionable feature (310) to generate the output (330) that describes why the subject may perform the action.

The labels for training data (328) may be generated from the subset of features (308) or from the actionable features (310), or both. For example, assume that feature X is selected. The data related to feature X for many different users may be gathered for the labels for training data (328).

An insight (i.e., the output (330)) may be associated with, or determined for, the labels for training data (328) and the actionable feature (310) using the correlation model (326). The insight may be, for example, noting that subjects (users of a software subscription in this example) having values within a range of Z for the feature X are twice as likely to churn (e.g., cancel the software subscription). The range of Z may indicate some past behavior of the subjects which suggest one or more reason(s) for why the users having feature values within the range of Z are more likely to churn. For example, users that login less than a predetermined number of times per month may be twice as likely to churn. Thus, one of the output (330) that such subjects may churn may be lack of use, or perhaps lack of understanding of the benefits of the software subscription. Again, the output (330) may be inferred by a correlation model being applied to the labels for training data (328) and the actionable feature (310).

The output (330) may be combined with the actionable features (310) (and possibly the propensity score itself) to generate the XAI context generation process (316). Again, the XAI context generation process (316) may be the combination of the output (330), the actionable features (310), and possibly the propensity value.

The XAI context generation process (316) may be used to generate a graphical user interface (GUI) that may be presented to a user device (332). The GUI may display the XAI context generation process (316) in a manner that is easily understandable to a technician (320). An example of the GUI is shown in FIG. 4C.

Attention is now turned to FIG. 4A through FIG. 4C, which shows examples of various aspects of the architecture (300) in use. In the example of FIG. 4A through FIG. 4C, the subject is a subscriber of a software program. The subscriber is calling a technician (320) to cancel the subscription because the subject is frustrated with the software application. The technician is willing to cancel the subscription, but would like to know why the subscriber wants to cancel the subscription. It may be possible that the technician can identify the reason for the subscribers desire to cancel the subscription, address the reason, and persuade the subscriber to retain the subscription.

FIG. 4A, shows an overview of the system and data flow described with respect FIG. 3, including specific examples of a subset of features, actionable features, and predicted reasons for why the subscriber may desire to cancel the subscription. In the example, the subscriber (the subject) is a user (400) named Bob. A propensity model has determined a churn score of 0.921 (indicating about a 92% chance that Bob is likely to cancel the subscription). The churn score is the propensity score (402).

A Shapley additive explanation tool has been applied to the propensity model, generating the subset of features (404) shown at 1a of FIG. 4A that are the features that contributed most strongly to the propensity score. The output of the Shapley additive explanation tool includes the identities of the subset of features, together with the relative contributions (406) of those features to the propensity score (402).

Next, the correlation model is applied to labels for training data and the actionable feature to determine the contextual reasons (408) why Bob may have such a high churn score. Then, the contextual reasons and the features are combined with domain expertise to generate a GUI (410) that displays the reasons for Bob's high church score, the basis for the reason (i.e., the features), and possible actions that may help a technician address Bob's problem with the software.

FIG. 4B shows an example of a target plot (412) which illustrates, in visual form, how the correlation model may identify a correlation between the labels for training data and the actionable feature in order to output the reason why Bob may perform the action of canceling the software subscription. Other subscribers (i.e. subjects other than Bob) and their propensities to cancel the subscription are determined from the training data. For clarity, the target plot (412) in this example is generated with respect to a single feature (414). The single feature is “modified transaction count” (i.e., “modified_transaction_cnt”).

The software in question permits users to modify the identified categories assigned to transactions recorded by the software. The higher the number of transitions that a user modifies, the higher the modified transaction count. Subjects with lower modified transaction counts are on the left, whereas users with higher modified transaction counts are on the right.

The propensity scores associated with the actionable feature for the various users are grouped into bins, such as bin (416), each indicating ranges of propensity scores (as shown at the bottom of the target plot (412)). The percentile bucket ranges are shown at the top of the target plot (412). The vertical axis indicates the number of users (on the left) and the churn rate (subscriptions actually canceled) on the right. The values in the boxes within the bins, such as bin (418), indicate the churn rate for that bin. It can be seen that subjects (past subscribers) that fall within the bin (416) have the highest churn rate, as indicated by bin (418).

Because the feature (414) is “modified transaction count” (i.e., “modified_transaction_cnt”), a domain expert, large language model, or other machine learning model may draw an inference (i.e., a correlation) that users with very low modified transaction counts are two and a half times more likely to cancel the subscription (i.e., to churn). Thus, it may be that such users do not understand the software, or may want help using the software's capability, or may not understand the software's capabilities. In each of these cases, the user may want or need help using the software. Thus, a reason (the user wants or needs help) is correlated to subjects that have low modified transaction counts (i.e., are within the first bin in the range of 0 to 28 modified transactions counted for those users). The subjects are described by the labels for training data and the actionable feature is the “modified_transaction_cnt.” Thus, the correlation model may take, as input, the labels for training data and the actionable feature. When executed on that input, the correlation model generates the output of the above reason(s) why Bob may cancel his subscription.

Specifically, in the example, Bob has a modified transaction count of 0. Thus, it may be seen how the correlation model may draw the correlation between the actionable feature for Bob (i.e., the “modified_transaction_cnt” value of 0 for Bob) and the labels for training data (i.e., the bin (416), which is drawn from the labels for training data) as shown in the target plot. With that correlation drawn, and a pre-determined reason or a computer-inferred reason associated with that particular correlation, the correlation model may then output the reason why Bob may want to cancel his subscription.

Stated differently, a pre-determined reason (failure to use or understand the software) has already been associated with the bin (418) of low transaction modification counts. Bob does not modify transactions using the software (Bob falls within bin (418)), so Bob is much more likely to cancel the subscription. Accordingly, it may be inferred that the pre-determined reason that is associated with the bin (418) applies to Bob. Specifically, the reason that is output is that Bob wants or needs help, or may not know about the software feature.

Note that, in reality, Bob himself may have some other real reason for wanting to cancel his subscription. The reason that the correlation model outputs is only a statistically most likely reason why users like Bob would want to cancel the subscription.

Nevertheless, because the company that hosts the software deals with many different users, overall more users than not who are like Bob may benefit from a customer service agent's understanding of Bob's most likely problem. On that basis, the customer service agent is more likely to be able to help Bob appreciate the benefits that the software brings to Bob's financial management tasks. Thus, across fielding many calls from many users like Bob, a customer service agent may be better able to reduce the overall churn rate by convincing Bob, or others like Bob, to retain the software subscription.

Note that different reasons may be associated with different target plots for different features. Likewise, different reasons may be associated with a single target plot depending on which bin Bob falls into. Thus, the example of FIG. 4B should not be considered a limiting example.

FIG. 4C shows a GUI (420) that conveys, in a format that is easily understandable to a human technician with whom Bob is interacting, Bob's churn risk (i.e. propensity score), the features that contributed to the propensity score (e.g., days_in_qbo), and a possible reason for high churn risk (e.g., the contextual reasons (408)). The churn risk (422) is shown as a gauge which is segmented into “low, “medium,” and “high” settings, each reflective of a range of propensity scores. Bob is identified as being at high risk of churning (canceling his subscription).

The features that contributed to the propensity score are converted into an easily human-readable format. Specifically, two features are identified, feature (424) and feature (426). The feature (424) indicates that Bob has no adjusted transactions (i.e., the “modified_transaction_cnt” features used in the propensity model). The feature (426) indicates that Bob has not logged into the software within 45 days (a “login” feature used in the propensity model).

A correlation model is applied to the labels for training data and to these two features. Together, two reasons (428) are generated and presented to the user. Specifically, the two reasons (428) are that Bob may be struggling to learn the software, and that Bob may be making mistakes that are frustrating Bob.

The human technician may then address Bob's issues quickly and easily while talking to Bob. While Bob may still cancel his subscription, it may be possible for the human technician to help Bob understand how to use the software and that the software may still be helpful to Bob. Bob may be convinced not to cancel the subscription. Thus, the human technician may be better equipped at reducing the churn rate of subscriptions via one or more embodiments.

Finally, a user feedback widget (430) is provided in the GUI. The user feedback widget (430) prompts the human technician (the user in the example) to provide feedback in the form of a “yes” or “no” response. The feedback may be used to retrain the correlation model, as described above.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores or micro-cores of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output devices may be the same or different from the input device(s) (510). The input and output device(s) may be locally or remotely connected to the computer processor(s) (502). Many different types of computing systems exist, and the aforementioned input and output device(s) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presentation methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
applying a propensity model to a subject vector to generate a propensity value estimating a probability that a subject will perform an action,
wherein the subject vector comprises a data structure having a plurality of features storing information regarding the subject;
applying, after applying the propensity model to the subject vector, a Shapley additive explanation tool to the propensity model to generate a subset of the plurality of features that contributed to the propensity value more than a remaining set of the plurality of features;
selecting an actionable feature from the subset of the plurality of features,
wherein the actionable feature comprises a feature in the subset that an entity is able to influence;
applying a correlation model to labels for training data and the actionable feature to generate an output that describes a reason why the subject performs the action; and
presenting the actionable feature and the output.

2. The method of claim 1, further comprising:
displaying, on a display device, the propensity value, the actionable feature, and the output.

3. The method of claim 1, wherein selecting the actionable feature comprises:
comparing the subset of the plurality of features to a library of actionable features, and
selecting, from among the subset, the actionable feature corresponding to an entry in the library.

4. The method of claim 3, further comprising:
building the library of actionable features from user input.

5. The method of claim 1, further comprising:
generating a target plot from the training data corresponding to the actionable feature; and
displaying the target plot on a display device.

6. The method of claim 5, wherein applying the correlation model comprises:
applying the correlation model to the labels for training data and the actionable feature to correlate a highest average propensity value for the action by a plurality of users to a common attribute among the plurality of users; and
returning the common attribute as the output describing the reason why the subject performs the action.

7. The method of claim 1, further comprising:
generating a target plot prior to applying the correlation model, wherein generating the target plot comprises:
receiving feature data from a plurality of subjects, wherein the feature data corresponds to the actionable feature, and
distributing the feature data into a plurality of bins,
wherein each of the plurality of bins represents a range of feature values for the actionable feature for the plurality of subjects, and
wherein each of the plurality of bins is associated with a value representing an average propensity value for the action for the plurality of subjects; and
displaying the target plot on a display device.

8. The method of claim 1, further comprising:
displaying, on a display device, a graphical user interface comprising the propensity value, the actionable feature, and the output;
displaying, on the graphical user interface, a widget requesting user input whether the display was helpful;
receiving a user response from activation of the widget; and
retraining the correlation model based on the user response.

9. A system comprising:
a processor;
a data repository in communication with the processor and storing:
a subject vector, comprising a data structure having a plurality of features storing information regarding a subject,
a propensity value estimating a probability that the subject will perform an action,
a subset of the plurality of features that contributed to the propensity value more than a remaining set of the plurality of features,
an actionable feature comprising a feature in the subset that an entity is able to influence,
labels for training data, and
an output that describes a reason why the subject performs the action;
a propensity model which, when applied by the processor to the subject vector, generates the propensity value;
a Shapley additive explanation tool which, when applied by the processor to the propensity model after generating the propensity value, generates the subset of the plurality of features; and
a correlation model which, when applied by the processor to the labels for training data and the actionable feature, generates the output.

10. The system of claim 9, further comprising:
a display device for displaying the actionable feature and the output.

11. The system of claim 9, further comprising:
a server controller which, when applied by the processor to the actionable feature and the output, generates a graphical user interface that displays the actionable feature, the output, and a suggested action.

12. The system of claim 9, wherein the subject comprises a subscriber to a software program, and wherein the action comprises the subject canceling a subscription to the software program.

13. The system of claim 9, wherein the data repository further stores a library of actionable features, and wherein the system further comprises:
a server controller which, when applied by the processor to the library and the actionable feature, selects, from among the subset, the actionable feature corresponding to an entry in the library.

14. The system of claim 9, wherein the data repository further stores a user response, and wherein the system further comprises:
a training controller which, when applied by the processor to the user response and the correlation model, retrains the correlation model based on the user response.

15. A method of machine learning training comprising:
applying a propensity model to a subject vector to generate a propensity value estimating a probability that a subject will perform an action,
wherein the subject vector comprises a data structure comprising a plurality of features storing information regarding the subject;
applying, after applying the propensity model to the subject vector, a Shapley additive explanation tool to the propensity model to generate a subset of the plurality of features that contributed to the propensity value more than a remaining set of the plurality of features;
selecting an actionable feature from the subset of the plurality of features,
wherein the actionable feature comprises a feature in the subset that an entity is able to influence;
applying a correlation model to labels for training data and the actionable feature to generate an output that describes a reason why the subject performs the action;
displaying, on a graphical user interface, a display comprising the propensity value, the actionable feature, and the output;
displaying, on the graphical user interface, a widget requesting user input whether the display was helpful;
receiving a user response from activation of the widget;
adding the user response to a training data set to generate a revised training data set; and
retraining the correlation model with the revised training data set.

16. The method of claim 15, wherein selecting the actionable feature comprises:
comparing the subset of the plurality of features to a library of actionable features, and
selecting, from among the subset, the actionable feature corresponding to an entry in the library.

17. The method of claim 16, further comprising:
building the library of actionable features from the user input.

18. The method of claim 15, further comprising:
generating a target plot from the training data corresponding to the actionable feature; and
displaying the target plot on a display device.

19. The method of claim 18, wherein applying the correlation model comprises:
applying the correlation model to the labels for training data and the actionable feature to correlate a highest average propensity value for the action by a plurality of users to a common attribute among the plurality of users; and
returning the common attribute as the output describing the reason why the subject performs the action.

20. The method of claim 15, further comprising:
generating a target plot from the training data corresponding to the actionable feature, wherein generating the target plot comprises:
receiving feature data from a plurality of subjects, wherein the feature data corresponds to the actionable feature, and
distributing the feature data into a plurality of bins,
wherein each of the plurality of bins represents a range of feature values for the actionable feature for the plurality of subjects, and
wherein each of the plurality of bins is associated with a value representing an average propensity value for the action for the plurality of subjects; and
displaying the target plot on a display device.
